(19) United States
(12) Patent Application Publication
(10) Pub. No.: US 2008/0238187 A1
(43) Pub. Date: Oct. 2, 2008

(54) Hydrostatic drive system with variable charge pump

(76) Inventors: Stephen Carl Garnett, Princeville, IL (US); Michael Jon Grichnik, Peoria, IL (US); Randall Alan Harlow, Brimfield, IL (US); David Jason McIntyre, Chillicothe, IL (US); Eric David Stemler, Peoria, IL (US); Timothy Lynn Hand, Metamora, IL (US); Adam Hendzel, Naperville, IL (US); Ryan Raymond Harken, Lowpoint, IL (US); Nathanael Garnet McRostie, Oswego, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/729,916

(22) Filed: Mar. 30, 2007

(51) Int. Cl. B60T 8/52

(52) U.S. Cl. 303/112; 180/199

(57) ABSTRACT

A hydraulic system is provided having a reservoir configured to hold a supply of fluid. The hydraulic system also has a variable displacement pump configured to supply charge fluid and pilot control fluid to the hydraulic system. In addition, the hydraulic system has a closed-loop portion configured to receive charge fluid from the variable displacement pump and drive a mechanism. The hydraulic system further has a pilot fluid supply portion configured to direct pilot control fluid from the variable displacement pump to closed-loop portion.

### TECHNICAL FIELD

The present disclosure is directed to a hydrostatic drive system, and more particularly, to a hydrostatic drive system having a variable charge pump providing pressurized make-up and pilot fluid.

### BACKGROUND

Differential steering systems are commonly used in many types of vehicles, including, for example, those vehicles designed for construction related activities. Each of these vehicles typically includes at least two ground engaging traction devices, which may be, for example, continuous belts, tracks, or tires. The ground engaging traction devices are disposed on opposite sides of the vehicle and may be rotated to propel the vehicle along a chosen path.

A differential steering system guides the vehicle along a chosen path by changing the relative velocity of the ground engaging traction devices. For example, to turn the vehicle to the left, the left ground engaging traction device is rotated at a slower velocity than or in a direction opposite to the right ground engaging traction device. To turn the vehicle to the right, the right ground engaging traction device is rotated at a slower velocity than or in a direction opposite to the left ground engaging traction device. The relative difference in velocities or directions causes the vehicle to turn in the direction of the slower ground engaging traction device or in the direction of the reverse moving traction device.

Some differential steering systems include a closed loop hydraulic circuit that has a variable pump and a hydraulic motor. The pump drives the motor to rotate a shaft in one of two directions. Rotation of the shaft in one direction causes one ground engaging traction device to rotate at a higher velocity than the other ground engaging traction device. Rotation of the shaft in the second direction causes the other ground engaging traction device to rotate at a higher velocity. The rotational velocity of the shaft dictates the magnitude of the velocity difference between the ground engaging traction devices.

Although closed loop hydraulic circuits can efficiently control the steering of traction devices, they may be problematic. For example, fluid flowing through a closed loop hydraulic circuit can escape through internal leaks in the pump and motor, thereby decreasing system pressure below acceptable margins of the pump and motor. In addition, because the hydraulic circuit is closed, fluid circulating in the loop can overheat under heavy load conditions. To compensate for the escaping and overheated fluid, closed loop circuits often employ fixed displacement pumps, also known as charge pumps. Charge pumps provide hydraulic power proportional to engine output at a constant pressure for system fluid makeup and control actuation.

Parasitic power losses are a concern with all hydraulic systems including closed-loop circuits having charge pumps. A major contributor to such parasitic losses is the wasted hydraulic power of the charge flow being throttled across a relief valve. This can occur under operating conditions where the charge flow is substantially greater than that required. One such operating condition occurs when the main pump is not providing flow to the motor (i.e., no steering is being affected). It has been observed that when the system operates under such conditions, the charge flow can be significantly reduced. In addition, fixed displacement pumps are often oversized to account for reduced performance due to wear. This can lead to parasitic losses in idle and other conditions.

One attempt to address parasitic power losses due to wasted hydraulic power can be found in U.S. Statutory Invention Registration No. H1977 (the '977 registration) issued to Poorman on Aug. 7, 2001. The '977 registration discloses a closed loop hydraulic system with variable charge pressure. The system includes a hydraulic motor and a variable displacement hydraulic pump in driven communication with a power source. The system also includes a charging circuit, which has a fixed-displacement charge pump, variable pressure relief valves, and an electro-hydraulic proportional relief valve. A controller varies the operating pressure setting of the proportional relief valve in response to a sensed pressure condition in the closed loop. By varying the operating pressure setting of the proportional relief valve, the charge pressure can be adjusted according to the needs of the closed loop system. Some parasitic power losses due to throttling are avoided by adjusting the system pressure.

Although the system in the '977 registration does reduce parasitic losses of a pressure system, it still may be suboptimal. Specifically, the system still pressurizes excess flow. Excess charge flow in low demand situations such as idling conditions can contribute to parasitic losses, even when little or no throttling occurs. Because the charge system flow remains unchanged, the system of the '977 registration can still incur an unacceptable level of parasitic loss.

Furthermore, the system in the '977 registration may be complex and expensive. That is, the system must use several additional components to vary the relief pressures such as a proportional relief valve and actuators to perform the adjustments. The use of additional components add to the complexity of the system and can increase system cost. Furthermore, using additional components increases the probability of system failure due to the break down of a component.

The closed loop hydraulic system of the present disclosure solves one or more of the problems set forth above.

### SUMMARY OF THE INVENTION

In one aspect, the present disclosure is directed toward a hydraulic system that includes a reservoir configured to hold a supply of fluid. The hydraulic system also includes a variable displacement pump configured to supply charge fluid and pilot control fluid to the hydraulic system. In addition, the hydraulic system includes a closed-loop portion configured to receive charge fluid from the variable displacement pump and drive a mechanism. The hydraulic system further includes a pilot fluid supply portion configured to direct pilot control fluid from the variable displacement pump to the closed-loop portion.

Consistent with another aspect of the disclosure, a method is provided for supplying fluid to a hydraulic system. The method includes pressurizing fluid to a first and a second pressure setting. The method also includes selecting one of the first and second pressure settings in response to a load signal. In addition, the method includes adjusting a flow of the fluid to maintain a desired operating pressure in response to a feedback signal. The method further includes directing the fluid to a hydraulic implement system and to a closed-loop hydraulic circuit.

### BRIEF DESCRIPTION OF THE DRAWINGS

FIG. 1 is a diagrammatic illustration of an exemplary disclosed machine;

FIG. 2 is a schematic illustration of a charging portion and a pilot control portion of a hydraulic system for the machine of FIG. 1; and

FIG. 3 is a schematic illustration of a steering loop portion of the hydraulic system for the machine of FIG. 1.

### DETAILED DESCRIPTION

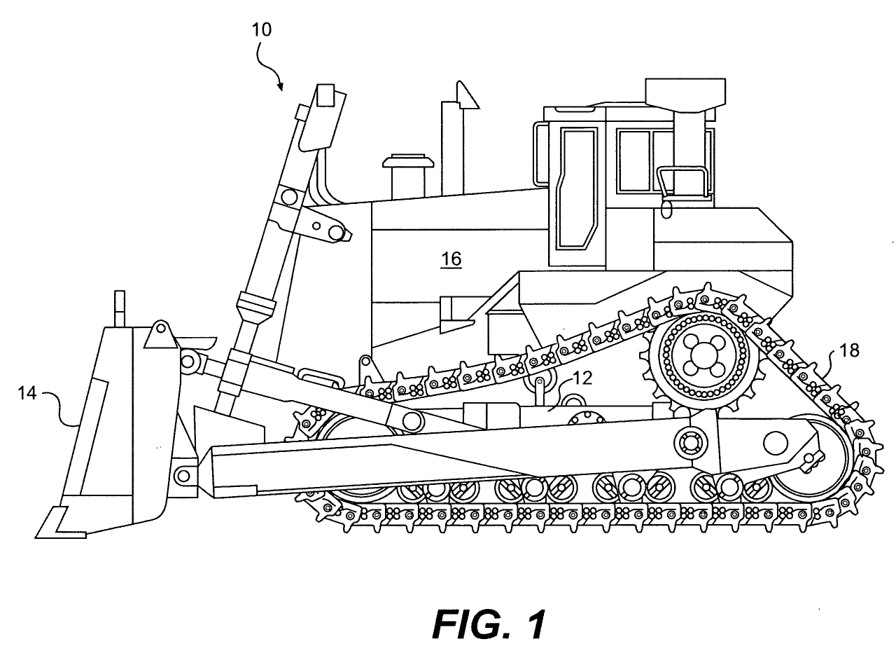

FIG. 1 illustrates an exemplary machine 10. Machine 10 may be a mobile machine that performs some type of operation associated with an industry such as mining, construction, farming, transportation, or any other industry known in the art. For example, machine 10 may embody the track-type tractor depicted in FIG. 1, a hydraulic excavator, a skid steer loader, an agricultural tractor, a wheel loader, a motor grader, a backhoe, or any other machine known in the art. Machine 10 may include a frame 12, at least one work implement 14, a power source 16, and at least one traction device 18.

Frame 12 may include any structural unit that supports movement of machine 10 and/or work implement 14. Frame 12 may be, for example, a stationary base frame connecting power source 16 to traction device 18, a movable frame member of a linkage system, or any other frame known in the art.

Work implement 14 may include any device used in the performance of a task. For example, work implement 14 may include a bucket, a blade, a shovel, a ripper, a dump bed, a hammer, an auger, or any other suitable task-performing device. Work implement 14 may pivot, rotate, slide, swing, or move relative to frame 12 in any other manner known in the art.

Power source 16 may embody an internal combustion engine such as, for example, a diesel engine, a gasoline engine, a gaseous fuel-powered engine such as a natural gas engine, or any other type of engine apparent to one skilled in the art. Power source 16 may alternatively embody a non-combustion source of power such as a fuel cell, a power storage device, or any other suitable source of power.

Traction device 18 may include tracks located on each side of machine 10 (only one side shown) and configured to support and propel machine 10. Alternately, traction device 18 may include wheels, belts, or other traction devices. Traction device 18 may or may not be steerable.

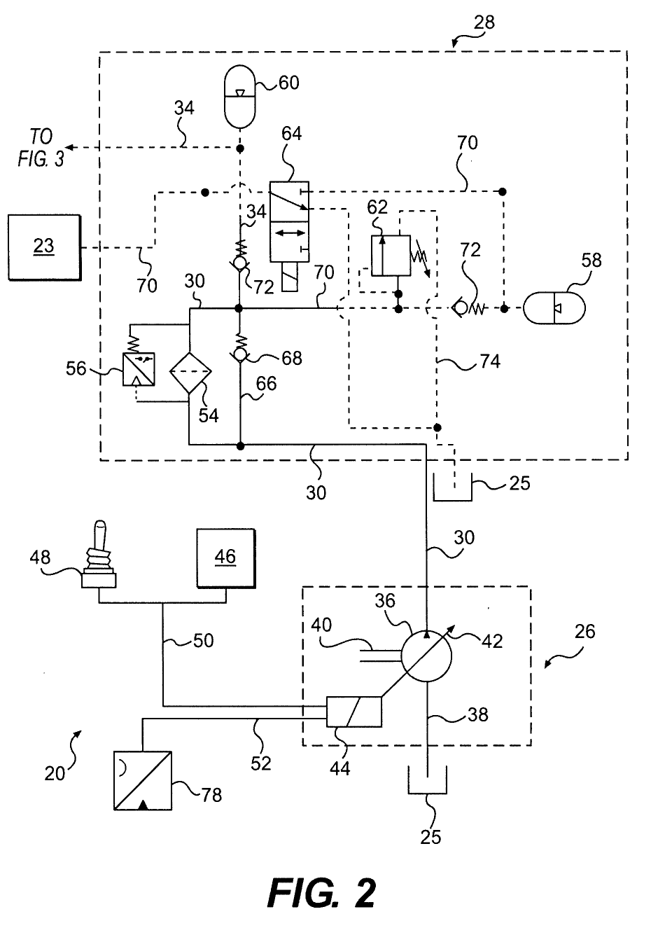

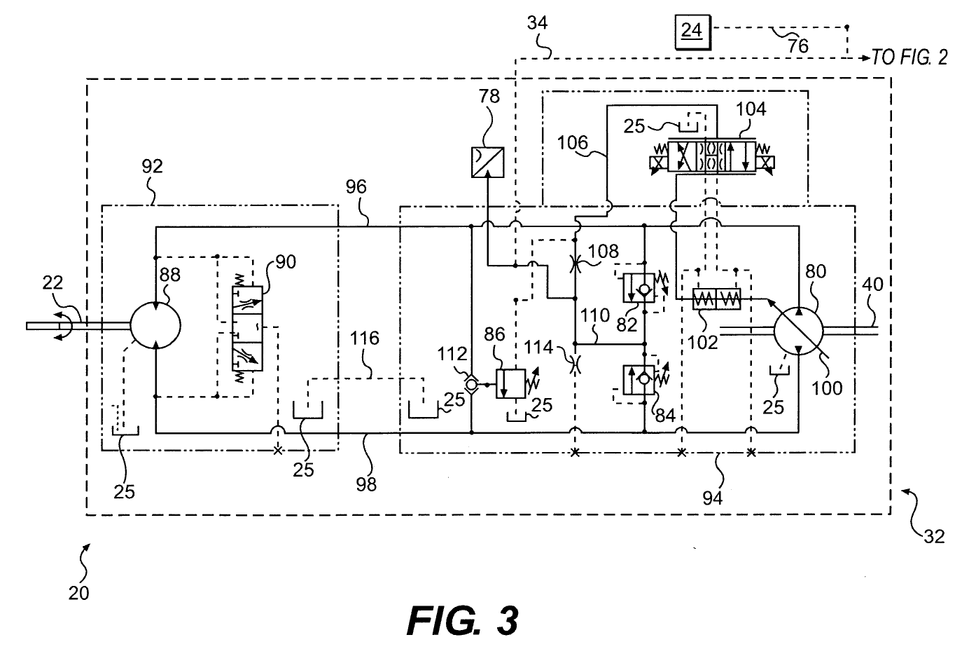

As illustrated in FIGS. 2 and 3, machine 10 may include a hydraulic system 20 having a plurality of fluid components that cooperate to actuate a steering device 22 (referring to FIG. 3) and supply pilot control fluid to additional hydraulic systems such as, for example, a work implement pilot control system 23 and a brake pilot control system 24 (referring to FIG. 3). Specifically, hydraulic system 20 may include a tank 25 holding a supply of fluid and a charging portion 26 fluidly connected to a pilot control portion 28 via a fluid passageway 30. Hydraulic system 20 may also include a hydrostatic drive portion 32 (referring to FIG. 3) in fluid communication with pilot control portion 28 via fluid passageway 34.

Tank 25 may constitute a reservoir configured to hold a supply of fluid. The fluid may include, for example, a dedicated hydraulic oil, an engine lubrication oil, a transmission lubrication oil, or any other fluid known in the art. One or more hydraulic systems within machine 10 may draw fluid from and return fluid to tank 25. It is also contemplated that hydraulic system 20 may alternatively be connected to multiple separate fluid tanks, if desired.

Charging portion 26 may replenish fluid that has been flushed from hydraulic system 20 to maintain a desired pressure. As illustrated in FIG. 2, charging portion 26 may include a charge pump 36 configured to draw fluid from tank 25 via a suction line 38 and produce a flow of fluid for pressurizing hydraulic system 20. Charge pump 36 may embody a variable displacement pump such as a swash plate-piston type pump or another type of pump configured to produce a variable flow of pressurized fluid. Furthermore, charge pump 36 may be drivably connected to power source 16 of machine 10 by, for example, a countershaft 40, a belt (not shown), an electrical circuit (not shown), or in any other suitable manner such that an output rotation of power source 16 results in a pumping action of charge pump 36.

Charge pump 36 may include a pump-flow control component such as a swash plate 42 to vary the stroke of one or more pistons (not shown) associated with the pump. By varying the stroke of the pistons, pump flow may be increased or decreased, as desired, thereby regulating the pressure of hydraulic system 20. Charge pump 36 may also include an actuator 44 operatively connected to swash plate 42 to regulate a displacement of charge pump 36. Actuator 44 may be hydraulically-controlled, electronically-controlled, mechanically-controlled, or operated in any other means to regulate a displacement angle of swash plate 42.

In one exemplary embodiment, charge pump 36 may be regulated by an electrohydraulic control system and may be set to operate at a first and a second predetermined pressure setting. The first pressure setting may be a stand-by pressure setting associated with an operation of charge pump 36 at its minimum displacement in a no-load situation. It should be understood that the stand-by pressure may vary depending upon the system requirements. For example, the stand-by pressure of charge pump 36 may be about 2400 kPa. The second pressure setting may be a high pressure cut-off setting equivalent to a maximum load acting on hydraulic system 20. For example, pilot control portion 28 may supply pilot control fluid to work implement pilot control system 23 for regulating the operation of work implement 14. When work implement 14 performs a blade float command, work implement pilot control system 23 may require pilot control fluid to be pressurized at approximately 3100 kPa. The pressure required by the blade float command may be greater than any other load acting on hydraulic system 20. Therefore, the pressure-cut off setting of charge pump 36 may be set to maintain a maximum pressure of approximately 3100 kPa.

Actuator 44 may be set to the high pressure cut-off mode or the stand-by pressure mode in response to an electronic or a hydraulic load sense signal from a solenoid valve 46 located in a work implement hydraulic system (not shown) and/or a direct manipulation of an actuation device 48, such as, for example, a joystick, button, knob, or other actuation device, located in an operator station (not shown). When actuation device 48 sends a blade float command signal to work implement 14, solenoid valve 46 and/or actuation device 48 may send a load sense signal to actuator 44 via a load sense signal line 50. Upon receiving the load sense signal, actuator 44 may operate in the high pressure cut-off mode. When the blade float command is completed, load sense signal may be terminated, and actuator 44 may operate in the stand-by pressure mode.

In addition, actuator 44 may regulate charge pump 36 in response to electronic or hydraulic feedback signals received from pressure sensors via a feedback line 52. The pressure sensors may be strategically placed at locations suitable for determining one or more circuit pressures in hydraulic system 20. For example, the pressure sensors may be placed in work implement pilot control system 23, brake pilot control system 24, and/or hydrostatic drive portion 32.

In another exemplary embodiment, charge pump 36 may be set to only operate at the high pressure cut-off setting. Charge pump 36 may regulate the pressure in hydraulic system 20 by varying the flow of fluid. Such a setting may be regulated by an electrohydraulic or a hydraulic control system, as disclosed above.

As described above, pressurized fluid from charge pump 36 may be directed to pilot control portion 28 via fluid passageway 30. Pilot control portion 28 may supply pilot control fluid to independent hydraulic systems utilized by machine 10. Such independent hydraulic systems may include, for example, the brake control system and the work implement pilot control system. In addition, pilot control portion 28 may act as a conduit for directing fluid from charging portion 26 to hydrostatic drive portion 32. Pilot control portion 28 may include a filtering element 54, a pressure switch 56, accumulators 58 and 60, a pressure relief valve 62, and an on-off valve 64. It is contemplated that pilot control portion 28 may include additional and/or different components such as, for example, makeup valves, pressure-balancing passageways, temperature sensors, position sensors, acceleration sensors, and other components known in the art.

Filtering element 54 may be disposed within fluid passageway 30 to remove debris and/or water from the oil downstream of charge pump 36. Pressure switch 56 may be associated with filtering element 54 to detect when the pressure of fluid passing through filtering element 54 falls below a preset limit such as, for example, approximately 170 kPa. An increase in a differential pressure above the preset limit may indicate that fluid from charge pump 36 may be bypassing filtering element 54 through a bypass 66. Fluid bypassing filtering element 54 may indicate that filtering element 54 is clogged. Under such circumstances, pressure switch 56 may be connected to illuminate a lamp or warning light (not shown) disposed within an operator station (not shown) of machine 10, thereby alerting an operator that filtering element 54 may be clogged. It should be understood that a check valve 68 may be located within bypass 66 and disposed downstream of charge pump 36 to prevent unfiltered fluid from flowing back into charge pump 36 when power source 16 is non-operational. Furthermore, check valve 68 may be sized for a pressure equaling the preset limit of pressure switch 56.

After passing through filtering element 54, fluid may be directed to work implement pilot control system 23 via a fluid passageway 70. Filtered fluid may also be directed to the brake pilot controls and hydrostatic drive portion 32 via fluid passage 34. It should be understood that the pilot control systems being supplied by pilot control portion 28 may need to be charged with fluid when power source 16 is non-operational and/or charge pump 36 has malfunctioned. Accumulators 58 and 60 may provide the fluid to the pilot control systems under such circumstances.

Accumulators 58 and 60 may each embody a pressure vessel filled with a compressible gas that is configured to store pressurized fluid for future use as a source of pilot control fluid. The compressible gas may include, for example, nitrogen or another appropriate compressible gas. As fluid in communication with accumulators 58 and 60 exceeds a predetermined pressure, it may flow into accumulators 58 and 60. Because the nitrogen gas is compressible, it may act like a spring and compress as the fluid flows into accumulators 58 and 60. When the pressure of the fluid within passageways 70 and/or 34 drops below a predetermined pressure, the compressed nitrogen within accumulators 58 and 60 may expand and urge the fluid from within accumulators 58 and 60 to exit accumulators 58 and 60. It is contemplated that accumulators 58 and 60 may alternatively embody a spring biased type of accumulator, if desired. The predetermined pressure may be, for example, approximately 1600 psi. In order to prevent fluid from draining out of accumulators 58 and 60 and flowing back into charging portion 26 when power source 16 is non-operational, check valves 72 may be provided within passageways 70 and 34. It should be understood that check valves 72 may be sized for a pressure equaling the predetermined pressures of accumulators 58 and 60.

Pressure relief valve 62 may minimize the likelihood of pressure spikes damaging the components of pilot control portion 28. In particular, pressure relief valve 62 may selectively communicate the pressurized fluid directed to pilot control portion 28 with tank 25 in response to a fluid pressure. In one example, pressure relief valve 62 may be in communication with the pressurized fluid from charge pump 36 via fluid passageway 70, and with tank 25 via a fluid passageway 74. Pressure relief valve 62 may have a valve element that is spring biased toward a valve closing position and movable toward a valve opening position in response to a pressure within fluid passageway 70 being above a predetermined pressure. In this manner, pressure relief valve 62 may reduce a pressure spike within pilot control portion 28 by allowing fluid having excessive pressures to drain to tank 25. It is contemplated that the predetermined pressure may be varied electronically, manually, or in any other appropriate manner to produce variable pressure relief settings.

In some circumstances, it may be desired to deactivate the work implement control system. On-off valve 64 may accomplish such a task by impeding the flow of fluid to work implement pilot control system 23. In particular, on-off valve 64 may be a solenoid operated valve operable to control fluid flow to the work implement pilot controls. In the exemplary embodiment shown, on-off valve 64 may be disposed within passageway 70 between accumulator 58 and work implement pilot control system 23. When on-off valve 64 is OFF, flow to and from work implement pilot control system 23 may be stopped, and when on-off valve 64 is ON, fluid may flow to and from work implement pilot control system 23. Accordingly, when on-off valve 64 is OFF, work implement 14 may be disabled because fluid flow to the work implement pilot controls may be redirected elsewhere.

As illustrated in FIG. 3, fluid may be directed from pilot control portion 28 (referring to FIG. 2) to hydrostatic drive portion 32 via fluid passageway 34, and to the brake pilot controls via fluid passageway 76. As fluid enters hydrostatic drive portion 32, a pressure sensor 78 associated with fluid passageway 34 may monitor a pressure of the fluid. Pressure sensor 78 may communicate the monitored pressure via feedback line 52 to actuator 44 in charging portion 26. Monitoring the pressure of the fluid entering hydrostatic drive portion 32 may provide feedback to charge pump 36 for maintaining a desired pressure within hydraulic system 20.

Hydrostatic drive portion 32 may be a closed loop circuit regulating steering device 22 to steer and propel traction device 18. Hydrostatic drive portion 32 may include a steering source 80 configured to direct pressurized fluid through hydrostatic drive portion 32. Furthermore, hydrostatic drive portion 32 may include crossover relief valves 82 and 84, a pressure override (POR) valve 86, a hydraulic actuator 88, a flushing valve 90, an actuator case drain 92, and a source case drain 94. It is contemplated that hydrostatic drive portion 32 may include additional and/or different components such as, for example, makeup valves, pressure-balancing passageways, temperature sensors, position sensors, acceleration sensors, and other components known in the art. It should be understood that although hydrostatic drive portion 32 is disclosed as a hydraulic steering system regulating steering device 22, hydrostatic drive portion 32 may be any type of closed-loop hydrostatic drive system known in the art.

Steering source 80 may produce a flow of pressurized fluid through a circuit formed by fluid passageways 96 and 98. Steering source 80 may embody a variable displacement pump or any other type of pump configured to produce a reversible variable flow of pressurized fluid. Furthermore, steering source 80 may be drivably connected to power source 16 of machine 10 by, for example, countershaft 40, a belt (not shown), an electrical circuit (not shown), or in any other suitable manner such that an output rotation of power source 16 results in a pumping action of steering source 80. Alternatively, steering source 80 may be indirectly connected to power source 16 via a torque converter, a gear box, or in any other appropriate manner.

Steering source 80 may include a pump-flow control component such as a swash plate 100 to vary the stroke of one or more pistons (not shown) associated with the pump. By varying the stroke of the one or more pistons, maximum pump flow may be increased or decreased, as desired. The displacement of swash plate 100 may be regulated by an actuator 102 operably connected to a swash plate 100, and a control valve 104.

Actuator 102 may be a hydraulic actuator, such as a double-acting hydraulic cylinder. One skilled in the art will recognize, however, that another type of actuator, such as, for example, another type of hydraulically-controlled actuator, a solenoid driven actuator, etc., may be used to vary the displacement of swash plate 102.

Control valve 104 may receive pilot control fluid via fluid passageway 106 and may be arranged in fluid communication with actuator 102. Furthermore, control valve 104 may effect actuation of actuator 102 and any desired swash plate displacement adjustment by controlling the flow of the pilot control fluid to actuator 102. A restrictive orifice 108 may be disposed within fluid passageway 106 and sized to minimize pressure and/or flow oscillations within fluid passageway 106. For example, orifice 108 may be sized to have a diameter of approximately 2.4 mm.

In the example shown, control valve 104 may be a 7-way, 3-position pilot operated directional, proportional control valve operable to control the flow of pressurized fluid to actuator 102. As the position of a spool within control valve 104 changes, fluid may be directed to actuator 102 at different rates, thereby regulating actuator 102. Springs and solenoids at each end of control valve 104 may bias control valve 104 to a neutral position, which may correspond to a no flow position.

As steering source 80 directs pressurized fluid through passageways 96 and 98, pressure in one of the passageways may build up to a level resulting in a greater than desired pressure differential between passageways 96 and 98. Such an undesired pressure differential may lead to undesired flow and/or damage to equipment. Cross-over relief valves 82 and 84 may ensure that the pressure differential between passageways 96 and 98 remains within a desired range by permitting hydraulic fluid to flow (i.e., cross over) from one side of the circuit over to the other. It should be understood that some of the fluid from pilot control portion 28 may be directed to cross-over relief valves 82 and 84 via passageway 110 to help maintain the desired pressure differential between passageways 96 and 98.

POR 86 may help regulate a peak pressure hydrostatic drive portion 32. In particular, POR 86 may selectively communicate the pressurized fluid in hydrostatic drive portion 32 with tank 25 in response to a maximum fluid pressure. In one example, POR 86 may be in communication with a shuttle valve 112. Shuttle valve 112 may direct fluid flowing at the highest pressure in the circuit to POR 86. In this manner, POR 86 may always receive fluid flowing at the highest pressure. It is contemplated that the predetermined pressure may be varied electronically, manually, or in any other appropriate manner to produce variable pressure relief settings.

Hydraulic actuator 88 may be a variable motor or a fixed displacement motor and may receive a flow of pressurized fluid from steering source 80. The flow of pressurized fluid through hydraulic actuator 88 may cause steering device 22, which may be connected to traction device 18, to rotate, thereby propelling and/or steering machine 10. It is contemplated that hydraulic actuator 88 may alternatively be indirectly connected to traction device 18 via a gear box or in any other manner known in the art. It is further contemplated that hydraulic actuator 88 may be connected to a different mechanism on machine 10 other than traction device 18 such as, for example a rotating work implement, a steering mechanism, or any other work machine mechanism known in the art.

As fluid flows between steering source 80 and hydraulic actuator 88, the temperature of the fluid may increase to levels capable of damaging the components of hydrostatic drive portion 32. Flushing valve 90, actuator case drain 92, source case drain 94, and an orifice 114 may prevent fluid flow through hydrostatic drive portion 32 from overheating. By directing some fluid into actuator case drain 92, flushing valve 90 may lower the overall pressure of hydrostatic drive portion 32. The lowered pressure may allow fresh temperate fluid to flow into hydrostatic drive portion 32, thereby lowering the overall temperature of the fluid flowing through hydrostatic drive portion 32. In addition, the flushed fluid flowing through actuator case drain 92 may absorb excess heat from fluid flowing in and out of hydraulic actuator 88. Orifice 114 may allow overheated fluid flowing in and out of steering source 80 to be flushed into source case drain 94. Again, this lowered pressure may allow fresh temperate fluid to flow into hydrostatic drive portion 32, thereby lowering the overall temperature of the fluid flowing through hydrostatic drive portion 32. In addition, the flushed fluid flowing through source case drain 94 may absorb excess heat from fluid flowing in and out of steering source 80. It is contemplated that orifice 114 may be sized to accommodate the control of fluid temperature. For example, orifice 114 may be sized to allow a flow of 5 LPM into source case drain 94.

Because hydraulic actuator 88 may encounter higher loads than steering source 80, fluid flowing in and out of hydraulic actuator 88 may be hotter than fluid flowing in and out of steering source 80. Therefore, fluid circulating throughout actuator case drain 92 may be hotter and less effective at temperature reduction than fluid flowing throughout source case drain 94. A Flush line 116 may allow fluid within source case drain 94 to flow into actuator case drain 92, thereby reducing the temperature of fluid within actuator case drain 92. Furthermore, flush line 116 may be fluidly connected to tank 25 and may allow fluid circulating in actuator case drain 92 and source case drain 94 to drain into tank 25.

### INDUSTRIAL APPLICABILITY

The disclosed hydraulic system may reduce parasitic losses by utilizing a variable displacement charge pump to charge and maintain pressure within the system. By pressurizing fluid and supplying the fluid to a closed loop hydraulic circuit only as required, rather than continuously pumping the fluid, engine power can be saved. In addition, because a variable displacement pump may be used to charge the closed-loop hydraulic circuit, any excess flow may be available to supply pilot fluid to other systems. Furthermore, parasitic losses associated with supplying pilot fluid at higher than required pressures can be reduced by utilizing the variable displacement charge pump. The operation of hydraulic system 20 will now be explained.

Referring to FIGS. 1-3, as power source 16 is started, counter shaft 40 may begin rotating charge pump 36 to draw fluid from tank 25 and discharge the fluid to passageway 30. The volume of fluid being drawn from tank 25 and discharged from charge pump 36 may be adjusted in response to feedback indicative of the fluid pressure of hydraulic system 20. Such feedback may be received from, for example, pressure sensor 78 located within hydrostatic drive portion 32. The flow of fluid may be increased when the pressure of hydraulic system 20 falls below a desired pressure. In contrast, the flow of fluid may be decreased when the pressure of hydraulic system 20 rises above a desired pressure.

In addition, the desired fluid pressure level may be adjusted in response to a load sense signal indicative of a blade float command or other maximum load acting on an associated work implement system. When the load sense signal is sent to charge pump 36, the desired pressure level may be increased to the maximum load setting. When the load sense signal is terminated or reduced, the desired pressure level may be reduced to the stand-by setting. It is contemplated that the desired pressure level may be permanently set to the maximum load setting, if desired. In such an embodiment, the pressure of hydraulic system 20 may be maintained by varying the flow of fluid in response to pressure feedback signals, as disclosed above.

After being discharged from charge pump 36, the fluid may be directed to pilot control portion 28. Fluid may flow through filtering element 54 to remove contaminants from the fluid. If filtering element is clogged, the fluid may be diverted through by-pass 66. In addition, pressure switch 56 may actuate a warning signal or light to alert an operator that filtering element 54 is clogged. After being filtered, the fluid flow may be divided so that a portion of the fluid may be directed to work implement pilot control system 23 and a portion of the fluid may be directed to brake pilot control system 24 and hydrostatic drive portion 32.

As fluid flows through passageway 70, the pressure may be further regulated according to the demands of work implement pilot control system 23. For example, if fluid is flowing through passageway 70 at a pressure higher than desired, pressure relief valve 62 may divert some of the flow to tank 25 until the pressure is reduced to the desired pressure. In addition, fluid may flow into accumulator 58 until it is filled to capacity and/or the pressure of the fluid in passageway 70 is substantially equivalent to the fluid in accumulator 58. Furthermore, before entering work implement pilot control system 23, fluid may pass through on-off valve 64. In an on mode, on-off valve 64 may direct the fluid to work implement pilot control system 23. In an off mode, on-off valve 64 may divert the fluid to tank 25.

As fluid flows through passageway 34, the flow may be directed to accumulator 60, to brake pilot control system 24 via passageway 76, and to hydrostatic drive portion 32. Before fluid enters brake pilot control system 24 and hydrostatic drive portion 32, accumulator 60 may be filled to capacity in a similar manner as accumulator 58. In addition, before the fluid enters hydrostatic drive portion 32, pressure sensor 78 may sense the fluid pressure in passageway 34 and send a feedback signal to charge pump 36.

Fluid entering hydrostatic drive portion 32 may be divided into pilot control fluid and make-up fluid. The pilot control fluid may be directed to control valve 104. Control valve 104 may regulate the flow of the pilot control fluid, as the pilot control fluid is directed to actuator 102. Control valve 104 may regulate the flow in response to received input signals from sensors in hydrostatic drive portion 32 or from an operator. The make-up fluid may be directed to a circuit created by passageways 96 and 98 via cross-over relief valves 82 and 84. Cross-over relief valves 82 and 84 may preserve a desired pressure differential between passageways 96 and 98. When the pressure differential between passageways 96 and 98 is outside of a desired range, cross-over valves 82 and 84 may allow fluid from one passageway to flow to the other. Introducing make-up fluid to the circuit through cross-over relief valves 96 and 98 may help maintain the desired pressure differential.

Utilizing a variable displacement pump to supply make-up fluid to a closed loop hydraulic system may provide a charge system capable of adjusting the flow based on demand. A demand-based adjustable flow can save energy and reduce parasitic losses in low-load situations. In particular, the disclosed variable displacement pump may require less energy when producing a reduced flow. As a result, the load acting on the engine may be reduced under low demand conditions, and engine power can be utilized more efficiently.

Furthermore, by utilizing a variable displacement pump in a fluid charge system may reduce the number of components necessary to regulate the pressure of the hydraulic system. The reduction of components in the system may reduce the complexity of the system and can reduce costs associated with those components. Furthermore, by reducing the number of components, the likelihood of system failure due to the break down of a component can be reduced.

It will be apparent to those skilled in the art that various modifications and variations can be made to the disclosed system. Other embodiments will be apparent to those skilled in the art from consideration of the specification and practice of the disclosed system. It is intended that the specification and examples be considered as exemplary only, with a true scope being indicated by the following claims and their equivalents.

What is claimed is:

1. A hydraulic system, comprising:
a reservoir configured to hold a supply of fluid;
a variable displacement pump configured to supply charge fluid and pilot control fluid to the hydraulic system;
a closed-loop portion configured receive charge fluid from the variable displacement pump and drive a transmission mechanism; and
a pilot fluid supply portion configured to direct pilot control fluid from the variable displacement pump to the closed-loop portion.

2. The hydraulic system of claim 1, wherein the pilot fluid supply portion is further configured to direct pilot control fluid from the variable displacement pump to a hydraulic implement system.

3. The hydraulic system of claim 2, wherein the variable displacement pump is configured to adjust a pump displacement in response to more than one input signal.

4. The hydraulic system of claim 3, wherein at least one of the more than one input signals includes a first signal indicative of an actual pressure of the closed-loop portion.

5. The hydraulic system of claim 4, wherein at least another of the more than one input signals includes a second signal indicative of a load acting on the hydraulic implement system.

6. The hydraulic system of claim 1, wherein the variable displacement pump is configured to operate at a pressure equivalent to a maximum pressure required by a pilot control system of the hydraulic implement system and at a lower stand-by pressure.

7. The hydraulic system of claim 6, wherein the variable displacement pump is configured to switch between the maximum pressure and the lower stand-by pressure in response to a signal associated with an actuation of a work implement.

8. The hydraulic system of claim 1, further including at least one fluid accumulator configured to supply fluid to the hydraulic system when the variable displacement pump is non-operational.

9. A method for supplying fluid to a hydraulic system, comprising:
pressurizing fluid to a first and a second pressure setting;
selecting one of the first and second pressure settings in response to a load signal;
adjusting a flow of the fluid to maintain a desired operating pressure in response to a pressure feedback signal; and
directing the fluid to a hydraulic implement system and to a closed-loop hydrostatic circuit.

10. The method of claim 9, wherein the first pressure setting is equivalent to a lower stand-by pressure.

11. The method of claim 10, wherein the second pressure setting is equivalent to a maximum pressure load acting on the hydraulic system.

12. The method of claim 9, wherein directing fluid to the hydraulic implement system includes supplying pilot control fluid.

13. The method of claim 9, wherein directing fluid to the closed-loop hydrostatic circuit further includes supplying charge fluid and pilot control fluid.

14. A machine, comprising:
a power source;
at least one traction device;
a work implement;
a reservoir configured to hold a supply of fluid; and
a variable displacement pump powered by the power source and configured to supply fluid to a pilot control portion and a closed-loop portion, wherein the pilot fluid supply portion is configured to direct fluid from the variable displacement pump to a hydraulic implement system, and the closed-loop portion is configured to receive fluid from the variable displacement pump and drive the at least one traction device.

15. The machine of claim 14, wherein the closed-loop portion is further configured to receive pilot control fluid from the variable displacement pump.

16. The machine of claim 14, wherein the variable displacement pump is configured to adjust a pump displacement in response to more than one input signal.

17. The machine of claim 16, wherein at least one of the more than one input signals includes a first signal indicative of an actual pressure of the closed-loop portion.

18. The machine of claim 17, wherein at least another of the more than one input signals includes a second signal indicative of a load acting on the hydraulic implement system.

19. The machine of claim 14, wherein the variable displacement pump is configured to operate at a pressure equivalent to a maximum pressure required by a pilot control system of the hydraulic implement system and at a lower stand-by pressure.

20. The machine of claim 19, wherein the variable displacement pump is configured to switch between the maximum pressure and the lower stand-by pressure in response to a signal associated with an actuation of a work implement.
